(19) United States
(12) Patent Application Publication
(10) Pub. No.: US 2026/0038309 A1
(43) Pub. Date: Feb. 5, 2026

(54) SYSTEM FOR CALCULATING ELECTRICAL EFFICIENCY OF ELECTRIC VEHICLE, SYSTEM FOR CALCULATING AVAILABLE TRAVEL DISTANCE, PROGRAM AND METHOD

(71) Applicant: YAMAHA HATSUDOKI KABUSHIKI KAISHA, Iwata-shi (JP)

(72) Inventor: Takeshi KASAI, Shizuoka (JP)

(21) Appl. No.: 19/289,175

(22) Filed: Aug. 4, 2025

(30) Foreign Application Priority Data
Aug. 5, 2024 (JP) 2024-129251

(51) Int. Cl. G07C 5/00; B60L 58/12; B62J 50/22; B62M 6/45

(52) U.S. Cl. CPC G07C 5/004; B60L 58/12; B62M 6/45; B60L 2200/12; B60L 2260/20; B62J 50/22

(57) ABSTRACT

An electrical efficiency calculation system includes one or more controllers configured or programmed to define and function as an interval electrical efficiency acquisition unit configured or programmed to acquire an interval electrical efficiency of an electric vehicle for each interval of a predetermined travel distance based on electric power consumed by the electric vehicle in the respective interval, a long distance electrical efficiency acquisition unit configured or programmed to acquire a long distance electrical efficiency based on electric power consumed by the electric vehicle in a travel distance longer than the predetermined travel distance, and an electrical efficiency calculation unit configured or programmed to calculate the electrical efficiency of the electric vehicle using a value obtained by multiplying a newest interval electrical efficiency and the long distance electrical efficiency by respective weighting factors, the newest interval electrical efficiency being an interval electrical efficiency for the newest interval.

### CROSS-REFERENCE TO RELATED APPLICATION

This application is based upon and claims the benefit of priority to Japanese Patent Application No. 2024-129251, filed on Aug. 5, 2024, the entire contents of which are hereby incorporated herein by reference.

### BACKGROUND OF THE INVENTION

### 1. Field of the Invention

The present invention relates to systems, non-transitory computer-readable media including programs, and methods for calculating the electrical efficiency of electric vehicles using a computer.

### 2. Description of the Related Art

The electricity consumption (i.e., rate of electric power consumption) of an electric vehicle and residual battery capacity (i.e., amount of remaining electric power) are used to estimate the cruising range of the electric vehicle. For example, Japanese Patent No. 5729191 discloses an apparatus for estimating the cruising range of a vehicle. The apparatus calculates a first electricity consumption based on the electric power consumed and travel distance in a first sampling interval, and calculates a second electricity consumption based on the electric power consumed and travel distance in a second sampling interval longer than the first sampling interval. Before an initialization condition is satisfied, the apparatus generates an estimated cruising range using the first electricity consumption, and generates such an estimated cruising range using the second electricity consumption when the initialization condition has been satisfied.

JP 2013-162618 A discloses an apparatus for calculating the rate of electric power consumption of a vehicle that is capable of performing learning of electricity consumption. In this learning of electricity consumption, electricity consumption (i.e., electricity consumption per interval) is calculated every predetermined time period (e.g., 5 minutes). The electricity consumption per interval is reflected in the learned electricity consumption learned in the past to perform learning of electricity consumption.

The electrical efficiency of an electric vehicle varies depending on the travel environment of the vehicle. As such, for example, the electrical efficiency calculated using the above conventional techniques changes in such a manner as to follow the travel environment. As a result, the calculated electrical efficiency may become less stable.

### SUMMARY OF THE INVENTION

A system for calculating an electrical efficiency of an electric vehicle according to an example embodiment of the present invention includes one or more controllers configured or programmed to define and function as an interval electrical efficiency acquisition unit configured or programmed to acquire an interval electrical efficiency of the electric vehicle for each interval of a predetermined travel distance based on electric power consumed by the electric vehicle in the respective interval, a long distance electrical efficiency acquisition unit configured or programmed to acquire a long distance electrical efficiency based on electric power consumed by the electric vehicle in a travel distance longer than the predetermined travel distance, and an electrical efficiency calculation unit configured or programmed to calculate the electrical efficiency of the electric vehicle using a value obtained by multiplying a newest interval electrical efficiency and the long distance electrical efficiency by respective weighting factors, the newest interval electrical efficiency being an interval electrical efficiency for a newest interval acquired by the interval electrical efficiency acquisition unit.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a functional block diagram illustrating an exemplary configuration of a system for calculating available travel distance, including a system for calculating electrical efficiency, according to an example embodiment of the present invention.

FIG. 2 is a left side view of an exemplary construction of an electric motor-assisted bicycle, which is an example of the electric vehicle.

FIG. 3 is a block diagram illustrating an exemplary mechanical and electrical connection configuration of components of the electric motor-assisted bicycle shown in FIG. 2.

FIG. 4 is a flow chart showing an exemplary process for calculating electrical efficiency by the electrical efficiency calculation system shown in FIG. 1.

FIG. 5 is a flow chart showing an exemplary process for calculating available travel distance by the available travel distance calculation system shown in FIG. 1.

FIG. 6 illustrates an exemplary process for calculating electrical efficiencies for various travel modes.

FIG. 7 illustrates another exemplary process for calculating electrical efficiencies for various travel modes.

### DETAILED DESCRIPTION OF THE EXAMPLE EMBODIMENTS

The electrical efficiency of an electric vehicle during traveling changes depending on the travel environment and user habits. The travel environment tends to change in short travel distances. On the other hand, user habits tend to change little over long distances. Thus, factors affecting electrical efficiency include factors that vary in relatively short travel distances and factors that vary in relatively long travel distances. The inventors of example embodiments of the present invention invented a system that strikes a balance between these multiple factors in calculating electrical efficiency.

A system for calculating an electrical efficiency of an electric vehicle according to an example embodiment of the present invention includes one or more controllers configured or programmed to define and function as an interval electrical efficiency acquisition unit configured or programmed to acquire an interval electrical efficiency of the electric vehicle for each interval of a predetermined travel distance based on electric power consumed by the electric vehicle in the respective interval, a long distance electrical efficiency acquisition unit configured or programmed to acquire a long distance electrical efficiency based on electric power consumed by the electric vehicle in a travel distance longer than the predetermined travel distance, and an electrical efficiency calculation unit configured or programmed to calculate the electrical efficiency of the electric vehicle using a value obtained by multiplying a newest interval electrical efficiency and the long distance electrical efficiency by respective weighting factors, the newest interval electrical efficiency being an interval electrical efficiency for a newest interval acquired by the interval electrical efficiency acquisition unit.

In the configuration described above, an interval electrical efficiency is acquired each time the electric vehicle travels a predetermined travel distance. Further, a long distance electrical efficiency is acquired that is based on electric power consumed in in a travel distance longer than the predetermined travel distance, i.e. the distance of one interval. Then, a value is obtained by multiplying the interval electrical efficiency in the newest interval by a weighting factor and another value is obtained by multiplying the long distance electrical efficiency by a weighting factor, which together are used to calculate electrical efficiency. These weighting factors adjust the weight of factors varying in the predetermined travel distance of one interval and the weight of factors that vary in a longer travel distance. This will enable calculating electrical efficiency while striking a balance between factors that vary in a relatively short travel distance and factors that vary in a relatively long travel distance. This will enable calculating electrical efficiency taking into account follow-up performance and stability relative to the travel environment.

Electrical efficiency is a value indicative of efficiency in terms of electric power for traveling. Electrical efficiency may be, for example, a value indicative of travel distance per unit amount of electrical energy, e.g., the distance that can be traveled with a unit capacity of the electrical energy source. Alternatively, electrical efficiency may be a value indicative of the amount of electrical energy per unit travel distance, i.e., the amount of electrical energy required to travel a unit travel distance. The term “electrical efficiency” could be replaced by “electricity consumption”. The unit of electrical efficiency is not limited to any particularly one, and may be, for example, km/Ah, m/Ah, m/As, km/Wh, m/Wh, m/Ws, Ah/m, Ah/km, As/m, Wh/km, Wh/m, or Ws/m.

In view of the configuration described above, the electrical efficiency calculation unit may be configured or programmed to calculate the electrical efficiency using a sum of a value obtained by multiplying the newest interval electrical efficiency by(P-a) as the respective weighting factor and a value obtained by multiplying the long distance electrical efficiency by α as the respective weighting factor. P is a constant, and 0<α<P. This will enable efficient calculation of electrical efficiency with regulated weights by a simple process.

In view of the configuration described above, the long distance electrical efficiency may be, for example, a multiple-interval electrical efficiency calculated based on electric power consumed in a plurality of intervals, or a total travel distance electrical efficiency calculated based on electric power consumed in the total travel distance of the electric vehicle.

The multiple-interval electrical efficiency may be, for example, calculated based on interval electrical efficiencies for a plurality of intervals prior to the newest interval. By way of example, the multiple interval electrical efficiency may be a previous electrical efficiency calculated by the electrical efficiency calculation unit with respect to the last interval before the newest interval.

In view of the configuration described above, the long distance electrical efficiency acquisition unit may be configured or programmed to acquire, as the long distance electrical efficiency, a previous electrical efficiency calculated by the electrical efficiency calculation unit with respect to a last interval before the newest interval. The electrical efficiency calculation unit may calculate the electrical efficiency using a value obtained by multiplying the newest interval electrical efficiency and the previous electrical efficiency by respective weighting factors.

This will facilitate providing sufficient follow-up performance of electrical efficiency relative to changes in the travel environment. The longer the travel distance of the electric vehicle, the larger the number of intervals in the past that provide a basis for long distance electrical efficiency. In the configuration described above, even if the travel environment significantly changes after a prolonged travel distance, sufficient follow-up performance of electrical efficiency relative to changes in the travel environment will be provided. It will be understood that the configuration above is an example where the long distance electrical efficiency is a multiple-interval electrical efficiency.

In view of the configuration described above, the long distance electrical efficiency acquisition unit may be configured or programmed to acquire, as the long distance electrical efficiency, a total travel distance electrical efficiency calculated based on electric power consumed in a total travel distance of the electric vehicle, and the electrical efficiency calculation unit may be configured or programmed to calculate the electrical efficiency using a value obtained by multiplying the newest interval electrical efficiency and the total travel distance electrical efficiency by respective weighting factors. This will enable calculating electrical efficiency taking into account the electric power consumed in the total travel distance and the electrical efficiency for the newest interval in well-balanced manner.

The total travel distance of the electric vehicle may be, for example, the distance traveled since the electric vehicle was produced until the current point of time. For example, the total travel distance of the electric vehicle may be measured by an odometer included in the electric vehicle.

Example embodiments of the present invention also include a system for calculating an available travel distance of an electric vehicle. The available travel distance calculation system includes the electrical efficiency calculation system described above. The available travel distance calculation system includes a residual battery capacity acquisition unit configured or programmed to acquire a residual battery capacity of a battery included in the electric vehicle, and an available travel distance calculation unit configured or programmed to calculate the available travel distance using the electrical efficiency calculated by the electrical efficiency calculation unit and the residual battery capacity, the available travel distance being a distance that the vehicle is able to travel using electric power from the battery of the electric vehicle. An available travel distance that is more likely to be correct is calculated based on an electrical efficiency that takes into account follow-up performance and stability relative to the travel environment.

By way of example, the weighting factor for the newest interval electrical efficiency may be larger than the weighting factor for the long distance electrical efficiency. That is, P/2>α can be used. In such implementations, the degree of contribution of the travel environment in the latest interval to the electrical efficiency may be higher than the degree of contribution of factors in a longer travel distance in the past to the electrical efficiency. This will enable increasing follow-up performance relative to the travel environment and, at the same time, calculating electrical efficiency taking into account stability.

The weighting factor for the newest interval electrical efficiency and the weighting factor for the long distance electrical efficiency may be updatable in response to an input by a user. This will enable the user to adjust the balance between the follow-up performance and stability of the calculated electrical efficiency relative to the travel environment.

The predetermined travel distance may be updatable in response to an input by the user. This will enable adjusting the travel distance in one interval.

The residual battery capacity may be calculated using the full charge capacity (FCC) and relative state of charge (RSOC) of the battery, for example. This will enable calculating the residual battery capacity taking account of the degree of degradation of the battery.

In view of the configuration described above, the electric vehicle is able to switch among a plurality of travel modes that use electric power in response to a selection operation by a user, and the electrical efficiency calculation unit may be configured or programmed to calculate an electrical efficiency for the travel mode selected by the user. A travel mode may be a mode of control of electric propulsion force added to propulsion force input by the user (e.g., pedaling force). For example, switching among travel modes may switch among manners in which the electric propulsion force responds to the propulsion force input by the user.

The electrical efficiency calculation unit may be configured or programmed to calculate the electrical efficiency for the selected travel mode using a value obtained by multiplying a selected mode newest interval electrical efficiency and a selected mode long distance electrical efficiency by respective weighting factors, the selected mode newest interval electrical efficiency being an interval electrical efficiency for the newest interval in the selected travel mode, the selected mode long distance electrical efficiency being a long distance electrical efficiency in the selected travel mode.

In such implementations, the interval electrical efficiency acquisition unit may be configured or programmed to acquire the interval electrical efficiency of the electric vehicle for each interval of the predetermined travel distance in each travel mode based on electric power consumed by the electric vehicle for that interval in that travel mode. The long distance electrical efficiency acquisition unit may be configured or programmed to acquire a long distance electrical efficiency based on electric power consumed by the electric vehicle in each mode in a travel distance longer than the predetermined travel distance.

Alternatively, the electrical efficiency calculation unit may be configured or programmed to calculate the electrical efficiency by calculating a value using a value obtained by multiplying the newest interval electrical efficiency and the long distance electrical efficiency by respective weighting factors and then correcting that calculated value depending on the selected travel mode. In such implementations, the interval electrical efficiency acquisition unit may be configured or programmed to acquire an interval electrical efficiency of the electric vehicle for each interval of the predetermined travel distance based on electric power consumed by the electric vehicle for that interval in any of the travel modes. The long distance electrical efficiency acquisition unit may be configured or programmed to acquire the long distance electrical efficiency based on electric power consumed by the electric vehicle in a travel distance in any of the travel modes, the travel distance in any of the travel modes being longer than the predetermined travel distance.

The correction may use the ratio of a value relating to the electric power used in the selected travel mode to a value relating to the average electric power used in a plurality of travel modes, or the difference therebetween. A value relating to the electric power used may be, for example, a value indicative of the amount of output of the motor included in the electric vehicle. The value indicative of the amount of output by the motor may be, for example, the ratio of motor output for assistance to pedaling force (i.e., assistance ratio). By way of example, the value relating to the average electric power used in the plurality of travel modes may be a value obtained by dividing, by the use time or use distance for all travel modes, the sum of the values obtained by weighting values relating to the electric power used in the various travel modes depending on the use time or use distance for the various modes.

For example, the electric vehicle may be an electric motor-assisted bicycle, and the plurality of travel modes may be a plurality of travel modes with different assist levels. In such implementations, the correction may use a value indicative of the ratio of a value relating to the electric power used for the assist level of the selected travel mode to a value relating to the electric power used for the average assist level of the plurality of travel modes, or the difference therebetween. The assist level may be an assistance ratio, for example. By way of example, the correction may use a value indicative of the ratio of the motor output for the assistance ratio of the selected travel mode to the motor output for the average assistance ratio of the plurality of travel modes.

In view of the configuration described above, the electric vehicle may be an electric motor-assisted bicycle. The electric motor-assisted bicycle includes a motor to output an assist force depending on a pedaling force input to a pedal. The amount of electric power consumed when the electric motor-assisted bicycle is not traveling is negligible. Thus, the electrical efficiency may be calculated without using data indicating travel time. This will enable efficient calculation of electrical efficiency using a simple process.

The interval electrical efficiency acquisition unit may be configured or programmed to acquire an interval electrical efficiency each time the electric motor-assisted bicycle travels the predetermined travel distance, and the electrical efficiency calculation unit may calculate an electrical efficiency each time the electric motor-assisted bicycle travels the predetermined travel distance.

In view of the configuration described above, the electric vehicle may be an electric motor-assisted bicycle, and the available travel distance may be an available assisted travel distance that the vehicle is able to travel with assistance that uses electric power from the battery.

The electric motor-assisted bicycle may include a plurality of wheels, a pedal to receive an input of a pedaling force by the user to drive at least one of the plurality of wheels, a motor to drive at least one of the plurality of wheels, a battery to supply the motor with electric power, and a controller configured or programmed to control an assist force output by the motor depending on the pedaling force. The controller may be configured or programmed to switch among a plurality of travel modes with different levels of assistance for pedaling force in response to a selection operation by the user.

Example embodiments of the present invention also include an electric vehicle including the above-described electrical efficiency calculation system or available travel distance calculation system. The electric vehicle may include a display to display the electrical efficiency calculated by the electrical efficiency calculation system or the available travel distance calculated by the available travel distance calculation system.

Now, systems according to example embodiments of the present invention will be described with reference to the drawings. In the drawings, the same and corresponding elements are labeled with the same reference numerals, and their description will not be repeated. In the description provided below, the directions “front/forward” and “rear (ward) ”, “left” and “right”, and “top/up (ward)” and “bottom/down (ward)” of an electric vehicle (by way of example, an electric motor-assisted bicycle) refer to such directions as perceived by a user on the vehicle. The directions “front/forward” and “rear (ward)”, “left” and “right”, and “top/up (ward)” and “bottom/down (ward)” of the electric vehicle are the same as the respective directions of the vehicle body, i.e., vehicle body frame, of the electric vehicle. Furthermore, the forward direction of the electric vehicle is aligned with the front-rear direction of the electric vehicle.

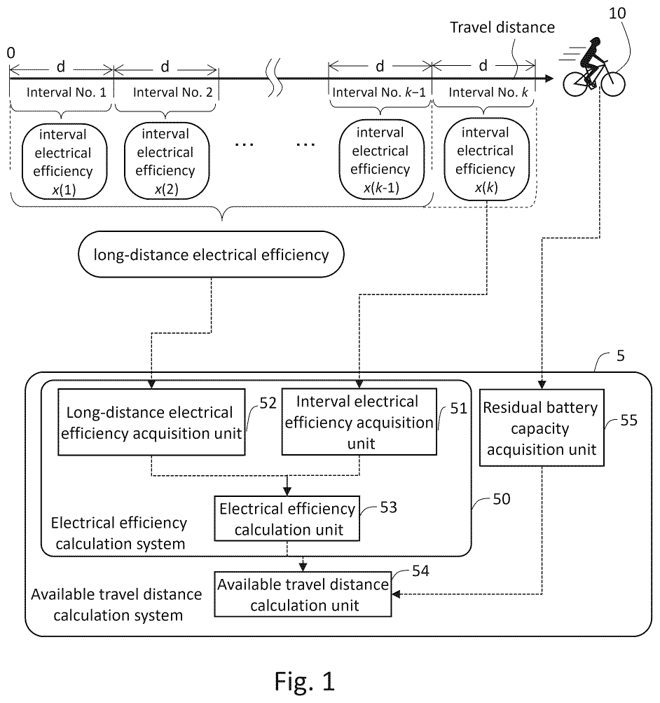

FIG. 1 is a functional block diagram illustrating an exemplary configuration of a system for calculating available travel distance, including a system for calculating electrical efficiency, according to the present example embodiment. In the exemplary implementation of FIG. 1, the electrical efficiency calculation system 50 calculates the electrical efficiency of the electric vehicle 10. The available travel distance calculation system calculates the available travel distance of the electric vehicle 10 based on the calculated electrical efficiency. According to the present example embodiment, by way of example, the electric vehicle 10 is an electric motor-assisted bicycle. The electrical efficiency calculation system 50 includes an interval electrical efficiency acquisition unit 51, a long distance electrical efficiency acquisition unit 52, and an electrical efficiency calculation unit 53. The available travel distance calculation system 5 further includes an available travel distance calculation unit 54 and a residual battery capacity acquisition unit 55.

The interval electrical efficiency acquisition unit 51 acquires an interval electrical efficiency x(n). Interval electrical efficiency x(n) is an electrical efficiency based on electric power consumed by the electric vehicle 10 for the associated interval of a predetermined travel distance d. Here, n is a natural number, indicating an interval number. x(k), when n=k, is the newest interval electrical efficiency. An interval electrical efficiency x(n) is calculated each time the electric vehicle 10 travels the predetermined travel distance d. In the implementation of FIG. 1, the intervals do not overlap each other. In other words, each interval electrical efficiency x(n) calculated is the electrical efficiency for the associated one of the plurality of intervals of the predetermined travel distance d that do not overlap each other. The interval electrical efficiency x(n) for each interval is calculated using the electric power consumed by the electric vehicle 10 for that interval,W(n), and the predetermined travel distance d. The interval electrical efficiency acquisition unit 51 may acquire a calculated interval electrical efficiency x(n), or may calculate x(n) using the consumed electric powerW(n). The interval electrical efficiency acquisition unit 51 may acquire the newest interval electrical efficiency x(k) upon termination of travel in the newest interval, for example. Thus, upon termination of travel in each interval, a newest interval electrical efficiency is acquired and made available for the electrical efficiency calculation system 50. The acquired newest interval electrical efficiency x(k) is stored on a storage device accessible to the electrical efficiency calculation system.

The long distance electrical efficiency acquisition unit 52 acquires a long distance electrical efficiency Y. The long distance electrical efficiency Y is an electrical efficiency based on the electric power consumed by the electric vehicle 10 in a travel distance longer than the predetermined travel distance d. The long distance electrical efficiency Y may be calculated, for example, using a total travel distance measured by an odometer included in the electric vehicle 10, dT, and the electric power consumed while the vehicle has been traveling the total travel distance dT, WT. Alternatively, the long distance electrical efficiency Y may be a previous electrical efficiency y(k-1) calculated by the electrical efficiency calculation unit 53. The long distance electrical efficiency acquisition unit 52 may acquire a calculated long distance electrical efficiency Y, or calculate a long distance electrical efficiency Y using the consumed electric power WT and total travel distance dT. The long distance electrical efficiency acquisition unit 52 may acquire the long distance electrical efficiency Y upon termination of travel in the newest interval, for example. Thus, upon termination of travel in each interval, a long distance electrical efficiency Y is acquired and made available for the electrical efficiency calculation system 50. The acquired long distance electrical efficiency Y is stored on a storage device accessible to the electrical efficiency calculation system.

The electrical efficiency calculation unit 53 calculates the electrical efficiency y(k) of the electric vehicle 10 using a value obtained by multiplying the newest interval electrical efficiency x(k) and long distance electrical efficiency Y by respective weighting factors. For example, the electrical efficiency y(k) calculated is the sum of values obtained by multiplying the newest interval electrical efficiency x(k) and long distance electrical efficiency Y by respective weighting factors, or a value obtained by correcting this sum. By way of example, the electrical efficiency y(k) may be calculated by the following calculation formulae:

$$y ( k ) = ( P - α ) \times x ( k ) + α \times Y ,$$

$$and$$

$$( 0 < α < P ) ,$$

where α is a weighting factor and P is a constant.

The electrical efficiency calculation unit 53 may calculate the electrical efficiency y(k) upon termination of travel in the newest interval. Thus, an electrical efficiency is calculated upon termination of travel in each interval. In other words, the electrical efficiency y(k) is updated each time the electric vehicle 10 travels the predetermined travel distance d. The electrical efficiency y(k) is stored on a storage device accessible to the electrical efficiency calculation system. The electrical efficiency y(k) can be said to be an electrical efficiency learned based on the electrical efficiencies in individual intervals and the long distance electrical efficiency, and thus could be referred to as learned electrical efficiency.

The residual battery capacity acquisition unit 55 acquires the residual battery capacity of the battery included in the electric vehicle 10. The residual battery capacity acquisition unit 55 may acquire the residual battery capacity from the battery control unit for the battery, for example. Alternatively, the residual battery capacity may be calculated based on voltage, current, or other values indicating battery conditions acquired from the battery. The residual battery capacity may be calculated using full charge capacity (FCC) and relative state of charge (RSOC) to the FCC, for example.

The available travel distance calculation unit 54 calculates available travel distance using the electrical efficiency y(k) calculated by the electrical efficiency calculation unit 53 and the residual battery capacity. The available travel distance is a distance that the electric vehicle 10 is able to travel using electric power from the battery. In implementations where the electric vehicle 10 is an electric motor-assisted bicycle, the available travel distance may be the remaining available distance with assistance. In implementations where the electrical efficiency y(k) is represented as a travel distance per unit amount of electrical energy, the available travel distance may be calculated by, for example, y(k)×residual battery capacity. In implementations where the electrical efficiency y(k) is represented as an amount of electric power per unit travel distance, the available travel distance may be calculated by, for example, (1/y(k))×residual battery capacity.

The electric vehicle 10 may be able to switch among a plurality of travel modes in response to a selection operation by the user. In such implementations, the electrical efficiency calculation unit 53 may calculate the electrical efficiency for the travel mode selected by the user. For example, the interval electrical efficiency acquisition unit 51 may acquire an interval electrical efficiency for each travel mode and the long distance electrical efficiency acquisition unit 52 may acquire a long distance electrical efficiency for each travel mode. In such implementations, the electrical efficiency calculation unit 53 may calculate the electrical efficiency y(k) for the selected travel mode using a value obtained by multiplying the interval electrical efficiency and long distance electrical efficiency for the selected travel mode by respective weighting factors. Alternatively, the interval electrical efficiency acquisition unit 51 may acquire the interval electrical efficiency for all travel modes and the long distance electrical efficiency acquisition unit 52 may acquire the long distance electrical efficiency for all the travel modes. In such implementations, the electrical efficiency calculation unit 53 is able to calculate the electrical efficiency y(k) by obtaining a value by multiplying the interval electrical efficiency and long distance electrical efficiency by respective weighting factors and correcting that value depending on the selected travel mode.

The electric vehicle 10 may include a plurality of wheels, a motor that drives at least one of the plurality of wheels, a battery that supplies the motor with electric power, a travel distance detection device, and a consumed-electric power detection device. The travel distance detection unit may include, for example, a rotational sensor that detects rotation of a wheel of the electric vehicle 10. The rotational sensor detects rotation of a wheel or a rotating body that rotates as a wheel rotates. The travel distance detection device allows the interval electrical efficiency acquisition unit 51 to acquire an interval electrical efficiency each time the device detects travel of the predetermined travel distance d. The consumed electric power detected by the consumed-electric power detection device may be discharge power of the battery, for example. Alternatively, the consumed electric power detected by the consumed-electric power detection device may be electric power consumed by the motor. The interval electrical efficiency acquisition unit 51 may acquire an interval electrical efficiency calculated based on the electric power consumed for each interval detected by the consumed-electric power detection device.

The electrical efficiency calculation system and available travel distance calculation system are implemented by one or more computers. In other words, the various functional units of the electrical efficiency calculation system and available travel distance calculation system may be implemented by a computer/computers performing a program. Each computer may include, for example, a CPU, an MPU (micro-processing unit), an MCU (micro-controller unit), a PLD (programable logic device), an FPGA (field-programmable gate array), an ASIC (application-specific integrated circuit) or other ICs. Example embodiments of the present invention include a program that performs the processes of the electrical efficiency calculation system and available travel distance calculation system, and a non-transitory storage medium storing such a program.

The electrical efficiency calculation system and available travel distance calculation system may be implemented by, for example, a vehicle mountable computer mounted on the electric vehicle 10. In such implementations, the electrical efficiency, interval electrical efficiency, and long distance electrical efficiency calculated by the electrical efficiency calculation unit may be stored on a vehicle mountable storage device mounted on the electric vehicle 10. The vehicle mountable computer or vehicle mountable storage device may include, for example, a computer included in a drive unit 40, a UI unit 70, a display device 71 in the electric motor-assisted bicycle, discussed further below, or any other vehicle mountable device. It will be understood that vehicle mountable devices include devices detachable from the electric vehicle 10, such as a cycle computer (i.e., cycle meter) mounted on the electric vehicle 10, or a smartphone. A computer or storage device included in such a detachable device may correspond to a vehicle mountable computer or vehicle mountable storage device.

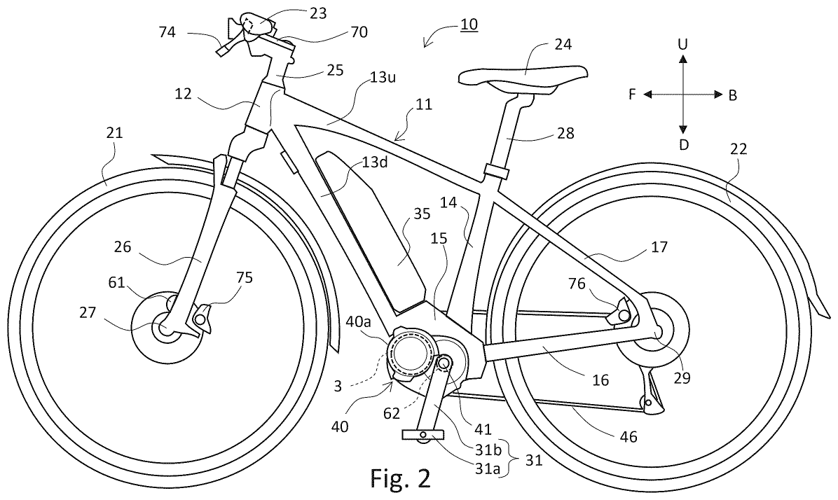

FIG. 2 is a left side view of an exemplary construction of an electric motor-assisted bicycle, which is an example of the electric vehicle 10. The characters F, B, U, and D in FIG. 2 indicate forward, rearward, upward, and downward, respectively. The electric motor-assisted bicycle includes a plurality of wheels 21 and 22, a vehicle body frame 11, a motor 3, a crankshaft 41, and pedals 31. The wheels 21 and 22, the crankshaft 41 and the pedals 31 are rotatably supported on the vehicle body frame 11. The electric motor-assisted bicycle 10 further includes a transmission mechanism that transmits rotation of the motor 3 to at least one of the wheels 21 and 22 and a transmission mechanism that transmits a pedaling force applied to the pedals 31 and crankshaft 41 to at least one of the wheels 21 and 22. At least one of the wheels 21 and 22 is driven by at least one of the pedaling force applied to the pedals 31 or the driving force generated by the motor 3.

The electric motor-assisted bicycle includes a pedaling force sensor 62 that detects a pedaling force applied by the rider. The pedaling force sensor 62 is provided around the crankshaft 41. The pedaling force sensor 62 detects a torque that rotates the crankshaft 41 about its axis. The pedaling force sensor 62 may be, for example, a non-contact torque sensor such as a magnetostrictive sensor, or a contact torque sensor such as an elastic-body variable detection-type sensor. A magnetostrictive torque sensor includes a magnetostrictive member that produces magnetostrictive effects and that receives a rotational force of the crankshaft, and a detection coil that detects a change in magnetic permeability caused by a force from the magnetostrictive member.

The electric motor-assisted bicycle includes a travel distance sensor 61. The travel distance sensor 61 may also have the function of a vehicle speed sensor. The travel distance sensor 61 is provided on the front fork 26, for example. The travel distance sensor 61 includes, for example, a detected element that rotates together with the front wheel 21 (i.e., wheel), and a detecting element fixed to the vehicle body frame 11 to detect rotation of the detected element. The detecting element detects the detected element in a mechanical, magnetic, or optical manner. It will be understood that the travel distance sensor 61 may detect rotation of a rotating body other than the front wheel 21 that rotates as the electric vehicle 10 travels forward, such as the rear wheel 22, motor 3, crankshaft 41, transmission gear, or chain. For example, the travel distance detected may be a value obtained by multiplying the detected number of rotations of the rotating body by the circumferential length of the tire (i.e., distance traveled by one rotation of the tire). Further, the vehicle speed detected is a value obtained by multiplying the number of rotations per unit time of the rotating body by the circumferential length of the tire.

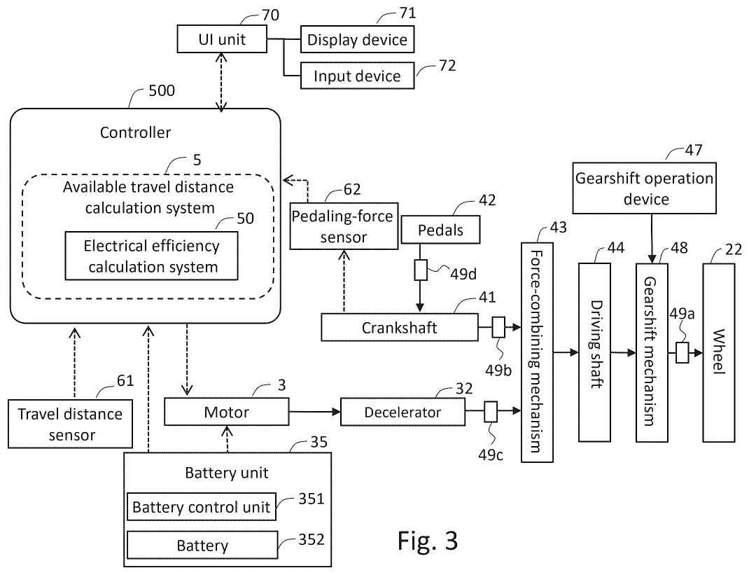

A battery unit 35 is located on the vehicle body frame 11. The battery unit 35 supplies the motor 3 of the drive unit 40 with electric power. The battery unit 35 includes a battery and a battery control unit, not shown. The battery is a chargeable battery that can be charged and discharged. The battery control unit controls the charging and discharging of the battery and, at the same time, monitors output current, discharge power, residual capacity, and other information about the battery. Information monitored by the battery control unit is not limited to these examples. For example, the battery control unit may not monitor discharge power. In such implementations, for example, the controller 500 of the electric vehicle (see FIG. 3) is able to calculate discharge power using the current and voltage relating to the battery supplied by the battery control unit.

The electric motor-assisted bicycle is provided with the user interface unit (i.e., UI unit) 70 that receives various operations by the user. The UI unit 70 includes, for example, an input device 72, such as a set of buttons or a touch screen, that receives user operations. The UI unit 70 may also include a display device (i.e., display) 72. In such implementations, the display device 71 and input device 72 may together define a touch panel. The display device 71 shows various information relating to the electric vehicle 10. For example, the display device 71 may display at least one of the electrical efficiency calculated by the electrical efficiency calculation unit 53 or the available travel distance calculated by the available travel distance calculation unit 54. The input device 72 may receive user operations to select a travel mode, for example. The UI unit 70 may include a device detachable from the electric vehicle 10, such as a cycle meter or smartphone.

FIG. 3 is a block diagram illustrating an exemplary mechanical and electrical connection configuration of components of the electric motor-assisted bicycle shown in FIG. 2. In the implementation shown in FIG. 3, rotation of the pedals 31 is transmitted to a force combining mechanism 43 via a one-way clutch 49d. Rotation of the motor 3 is transmitted to the force combining mechanism 43 via a decelerator 32 and a one-way clutch 49c. The force combining mechanism 43 includes, for example, a synthesizing mechanism, a driving sprocket, a chain, and a driven sprocket. The synthesizing mechanism synthesizes the rotation of the crankshaft 41 and the rotation of the motor 3 before transmission to the driving sprocket. Within the force combining mechanism 43, a driving force is transmitted through the synthesizing mechanism, driving sprocket, chain 46, and driven sprocket in this order. Rotation of the driven sprocket is transmitted to the rear wheel 22 via a driving shaft 44, a gearshift mechanism 48, and a one-way clutch 49a. The gearshift mechanism 48 changes the gear ratio in response to an operation of a gearshift operation device 47 by the rider.

The pedaling force generated by the rider pressing the pedals 31 rotates the crankshaft 41 in the forward direction. The rotation of the crankshaft 41 is transmitted, via the transmission mechanism, to the rear wheel 22. The rotational force output by the motor 3 is transmitted as a driving force that rotates the rear wheel 22 in the forward direction. If the pedaling force applied by the rider and the rotational force output by the motor 3 are transmitted to the rear wheel simultaneously, the rotational force output by the motor 3 is added, as assistance, to the pedaling force applied by the rider. In a variation the rotational force generated by operation of the motor 3 may rotate the crankshaft 41 in the forward direction. In another variation, the rotational force output by the motor 3 may be transmitted to the front wheel 21. In other words, the transmission mechanism may be configured such that the rotation output by the motor is transmitted to a wheel different from the wheel to which the rotation of the crankshaft 41 is transmitted. In such implementations, no synthesizing mechanism that would synthesize the pedaling force and the output of the motor is necessary.

In the implementation of FIG. 3, the electric motor-assisted bicycle includes a controller 500. The controller 500 includes the available travel distance calculation system 5 and electrical efficiency calculation system 50 (hereinafter sometimes simply referred to as system 5, 50). For example, a computer mounted on a circuit board within the housing 40a of the drive unit 40 may correspond to the controller 500. The controller 500, i.e., the system 5, 50 is electrically connected to the travel distance sensor 61, pedaling force sensor 62, motor 3, battery unit 35, and UI unit 70. These connections may use cables, or may be wireless.

The controller 500 controls the output of the motor 3 depending on the pedaling force detected by the pedaling force sensor 62. The controller 500 causes the motor 3 to output an assist force depending on the pedaling force. The motor 3 may be controlled so as to output a response to a pedaling force differently depending on the travel mode. For example, the controller 500 may switch among a plurality of travel modes with different levels of assistance for pedaling force depending on the selection operation by the user.

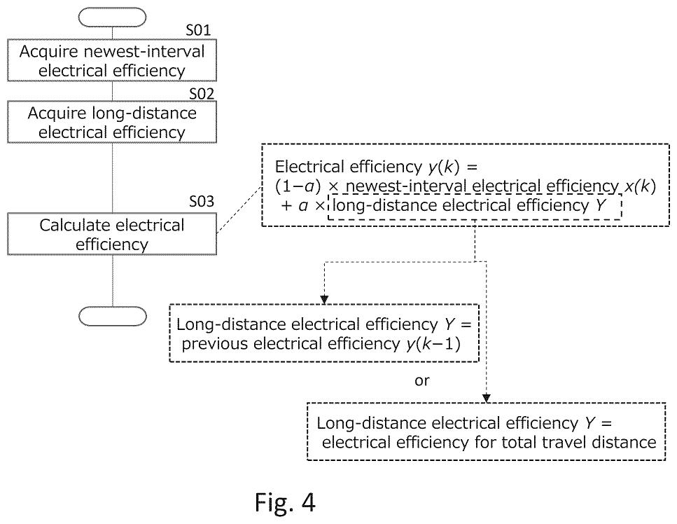

FIG. 4 is a flow chart showing an exemplary process for calculating electrical efficiency by the electrical efficiency calculation system 50 shown in FIG. 1. At step S01, the interval electrical efficiency acquisition unit 51 acquires a newest interval electrical efficiency x(k). The newest interval electrical efficiency x(k) is calculated by, for example, obtaining an amount of discharge power W(k) for travel of the predetermined travel distance d of the newest one interval and converting that amount of discharge power into an amount of discharge power per unit distance (W(k)/d) or into a travel distance per unit power (d/W(k)). The amount of discharge power for travel in the newest one interval W(k) may be a value obtained by integrating or accumulating the discharge power of the battery during travel of the predetermined travel distance d of one interval, for example. Travel of the predetermined travel distance d may be detected by the travel distance sensor 61. The discharge power of the battery may be acquired from the battery control unit 351 of the battery unit 35, for example.

By way of example, the amount of discharge power W(k) [Ws] for travel in the newest one interval may be calculated by the expression given below. The unit of the amount of electric power is not limited to [Ws], and may be Wh, mWh, mWs, As, Ah, or mAs, for example.

$$W ( k ) = {\int }_{0}^{T} w ( t ) dt \{ \begin{matrix}W ( k ) : amount of discharge power [ ws ] \\ W : discharge power [ w ] \\ T : time [ s ] \\ T : time required for travel in one interval [ s ]\end{matrix} \qquad Expression 1$$

At step S02, the long distance electrical efficiency acquisition unit 52 acquires a long distance electrical efficiency Y. The long distance electrical efficiency Y is calculated, for example, using a total travel distance dT and the total electric power consumed during travel of the total travel distance dT, WT. By way of example, the long distance electrical efficiency Y may be calculated by dT/WT or WT/dT. The total travel distance dT may be calculated by integrating or accumulating the travel distances detected by the travel distance sensor 61, for example. The total consumed electric power WT is calculated by integrating or accumulating the discharge power of the battery unit 35, for example.

In another exemplary implementation, the long distance electrical efficiency Y may be a previous electrical efficiency y(k-1) calculated by the electrical efficiency calculation unit 53 with respect to the last interval before the newest interval. In other words, the long distance electrical efficiency may be a previous learned electrical efficiency. The electrical efficiency calculation unit 53 calculates the electrical efficiency with respect to each interval. In other words, upon termination of travel of the electric vehicle 10 in one interval of the predetermined travel distance d, electrical efficiency is calculated based on the newest interval electrical efficiency for a newest interval represented by that interval and the long distance electrical efficiency. Thus, the previous electrical efficiency y(k-1) is an electrical efficiency calculated based on the electrical efficiencies for the plurality of intervals from the first interval until the last interval before the newest interval. For calculation of electrical efficiency after travel in the first interval, the long distance electrical efficiency used may be a predetermined value (i.e., default value).

The electrical efficiency calculation unit 53 uses the newest interval electrical efficiency x(k) acquired at step S01 and the long distance electrical efficiency Y acquired at step S02 to calculate the electrical efficiency y(k). For example, y(k) may be calculated using the expression shown in FIG. 4, y(k)=(1−α)×x(k)+α×Y. α is a weighting factor, and 0<α<1 in this example. The electrical efficiency y(k) may be converted into another unit as necessary. For example, if the unit of the calculated electrical efficiency y(k) is the amount of electric power for 1 km (by way of example, in the unit [mWs/km]), the following expression may be used for conversion into the electrical efficiency in the unit [m/Wh] of travel distance for 1 Wh, ye(k):

$$ye ( k ) = ( 3600 \times 1000 \times 1000 ) / y ( k )$$

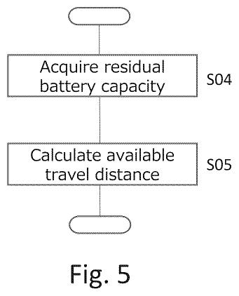

FIG. 5 is a flow chart showing an exemplary process for calculating available travel distance by the available travel distance calculation system 5 shown in FIG. 1. At step S04, the residual battery capacity acquisition unit 55 acquires a residual battery capacity. The residual battery capacity may be calculated by the equation given below, for example. The residual battery capacity may be calculated, for example, by the battery control unit 351 of the battery unit 35 or calculated by the residual battery capacity acquisition unit 55.

Residual battery capacity[Wh]=FCC[Wh]×RSOC[%]/100

The available travel distance calculation unit 54 calculates available travel distance by multiplying together the electrical efficiency calculated at step S03 and the residual battery capacity acquired at step S04. By way of example, the available travel distance is a remaining available distance with assistance. The available travel distance is calculated by the expression given below, for example. The calculated available travel distance is displayed on the display device included in the electric vehicle 10, for example.

$$Available travel distance [ m ] = electrical efficiency [ m / Wh ] \times residual battery capacity [ Wh ]$$

The available travel distance calculation process in FIG. 5 may be performed in a timing that does not depend on the electrical efficiency calculation process in FIG. 4. For example, the available travel distance calculation may be performed in a predetermined cycle. Alternatively, an available travel distance may be calculated each time the vehicle travels a travel distance ds (ds<d) that is shorter than the predetermined travel distance d of one interval. Alternatively, available travel distance may be calculated at least upon calculation of electrical efficiency, i.e., upon update of electrical efficiency.

The above process in FIG. 4 calculates an electrical efficiency that has been learned based on the electrical efficiency with respect to the newest interval and the long distance electrical efficiency. Thus, an electrical efficiency is calculated that reflects user-specific use conditions such as the travel environment, the manner in which the user uses the vehicle, and characteristics of the electric vehicle. The process in FIG. 5 uses this electrical efficiency to calculate available travel distance, thus calculating an available travel distance in accordance with the user's use conditions. This will reduce the discrepancy between the available travel distance presented to the user and the distance that the vehicle is actually able to travel using electric power.

Further, in the above exemplary implementation, a weighting factor α can be set. Adjusting the weighting factor α enables adjusting the follow-up performance and stability of the calculated electrical efficiency or available travel distance relative to changes in the travel environment. The weighting factor α determines the ratio between the degrees of contribution of the newest interval electrical efficiency and long distance electrical efficiency. Increasing the weighting factor α increases the ratio of the long distance electrical efficiency. This will reduce variations in the calculated electrical efficiency due to changes in use conditions, thus increasing stability. Reducing the weighting factor α increases the ratio of the newest interval electrical efficiency. This will increase the follow-up performance of the calculated electrical efficiency relative to changes in use conditions. The term “weighting factor” a could also be replaced by “filter factor”.

At step S02 in FIG. 4, in implementations where the long distance electrical efficiency Y is the previous electrical efficiency y(k-1), the follow-up performance of the calculated electrical efficiency relative to changes in use conditions will be higher than in implementations where the long distance electrical efficiency Y is the electrical efficiency for the total travel distance. In implementations where the long distance electrical efficiency Y is the electrical efficiency for the total travel distance, the longer the total travel distance, the more slowly the calculated electrical efficiency will follow changes in use conditions. In contrast, in implementations where the long distance electrical efficiency Y is the previous electrical efficiency y(k-1), sufficient follow-up performance will be provided. This is because the electrical efficiencies for old intervals are compressed and the degree of contribution of the electrical efficiencies for new intervals is increased. For example, in cases where the total travel distance of the electric vehicle is already long and then use conditions dramatically change (e.g., the user moves to another address or the electric vehicle 10 is purchased as a secondhand article), the calculated electrical efficiency will follow changes without a delay.

The electric vehicle 10 may be able to switch among a plurality of travel modes that use electric power in response to a selection operation by the user. In implementations where the electric vehicle 10 is an electric motor-assisted bicycle, the plurality of travel modes may be a plurality of travel modes with different assist levels. By way of example, the plurality of travel modes may include an eco-mode with low assist level and reduced electric power consumed, a normal mode with normal assist level and providing standard assistance, and a high mode with high assist level and providing powerful assistance. The electrical efficiency calculation unit 53 may be configured or programmed to calculate the electrical efficiency for the travel mode selected by the user. Thus, when the user selects a travel mode, the electrical efficiency for the selected travel mode and the available travel distance for this travel mode may be calculated and presented to the user.

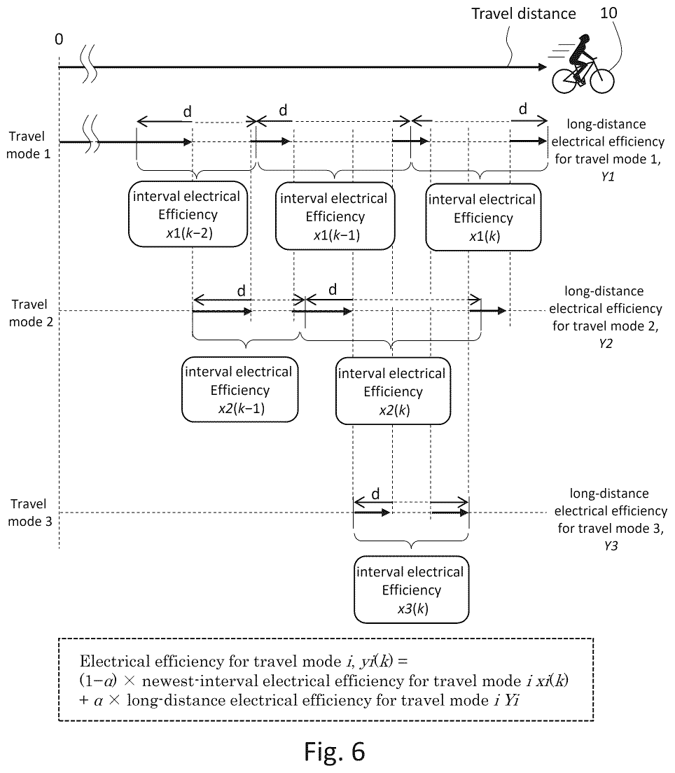

FIG. 6 illustrates an exemplary process for calculating electrical efficiencies for various travel modes. In the exemplary implementation of FIG. 6, for each of travel modes 1 to 3, the interval electrical efficiency xi (n) for each interval of the predetermined travel distance d is calculated. In other words, the interval electrical efficiency acquisition unit 51 acquires an interval electrical efficiency xi (n) for each interval in each travel mode. i is the number of a travel mode. In the present implementation, i=1, 2, or 3. For each travel mode, the long distance electrical efficiency acquisition unit 52 acquires a long distance electrical efficiency Yi. A long distance electrical efficiency Yi may be the total travel distance for the associated travel mode, or may be the previous electrical efficiency for the associated travel mode. The electrical efficiency calculation unit 53 calculates an electrical efficiency for the selected travel mode using a value obtained by multiplying the newest interval electrical efficiency xi(k) for the selected travel mode i and the long distance electrical efficiency Yi for the selected travel mode by respective weighting factors.

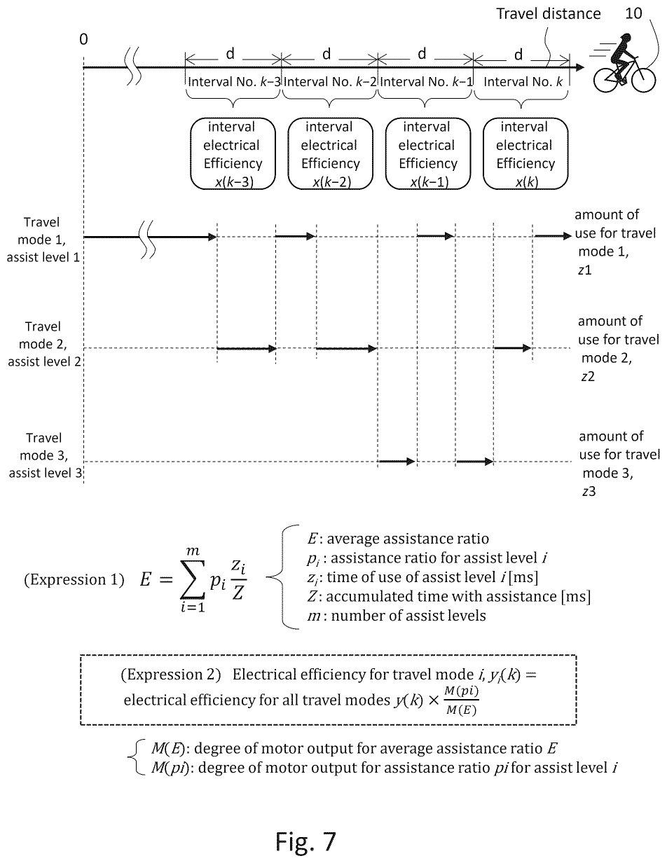

FIG. 7 illustrates another exemplary process for calculating electrical efficiencies for various travel modes. In the exemplary implementation of FIG. 7, an interval electrical efficiency x(n) is calculated for each interval of the predetermined travel distance d for all travel modes. In other words, regardless of the selected travel mode, an interval electrical efficiency x(n) is acquired each time the vehicle travels the predetermined travel distance d. The long distance electrical efficiency is an electrical efficiency based on electric power consumed in a travel distance longer than d in all travel modes. In other words, the long distance electrical efficiency acquired is an electrical efficiency based on electric power consumed when the vehicle has traveled a travel distance longer than d, regardless of the travel mode. The electrical efficiency calculation unit 53 calculates the electrical efficiency yi(k) for travel mode i by obtaining a value by multiplying the newest interval electrical efficiency x(n) and long distance electrical efficiency by respective weighting factors, using that value to calculate a value y(k), and correcting the value y(k) in accordance with the selected travel mode i. For example, the value y(k) is corrected using a correction value corresponding to the selected travel mode i to calculate a corrected electrical efficiency yi(k) for travel mode i. The corrected value may be, for example, the ratio of the electric power used for the selected travel mode to the average electric power used for the plurality of travel modes, or the difference therebetween.

In the implementation of FIG. 7, the amount of use for each travel mode, zi, is calculated. The amount of use zi for each travel mode may be, for example, a time for which the assistance at assist level i in each travel mode i has been used. The amount of use in each travel mode is not limited to the use time for each travel mode, and may be the distance traveled in each travel mode, the frequency of use of each travel mode, or any other value indicative of the amount of use. Based on the amount of use for the various travel modes zi, the average electric power used in the plurality of travel modes and the electric power used in each travel mode are calculated. A value indicative of the ratio of the electric power used in the selected travel mode to the average electric power used is used to decide on a correction value for the selected travel mode. For example, the electrical efficiency yi(k) for the selected travel mode is calculated by multiplying the electrical efficiency y(k) for all travel modes by the correction value for the selected travel mode i.

In the implementation of FIG. 7, y(k) is corrected using a value M(pi)/M(E), indicative of the ratio of the degree of motor output M(pi) for the assistance ratio pi for the selected travel mode i to the degree of motor output M(E) for the average assistance ratio E for the plurality of travel modes. Expression 1 in FIG. 7 gives an exemplary calculation of the average assistance ratio E. Expression 2 gives an exemplary calculation of the electrical efficiency yi(k) for the selected travel mode i. In expression 2, the correction value used is M(pi)/M(E). The assistance ratio is the ratio of the motor output to the pedaling force input. For example, the assistance ratio may be the ratio of the motor output when the pedaling force is 1. Expression 2 in FIG. 7 is an example where the unit of the electrical efficiency yi(k) is the amount of electric power per unit distance (e.g., [mWs/km]). If the unit of electrical efficiency is the travel distance per unit electric power (e.g., m/Wh), the correction value is the reciprocal of M(pi)/M(E).

In the implementation of FIG. 6, the electrical efficiency yi(k) for each travel mode is calculated using the interval electrical efficiencies xi(k) and long distance electrical efficiency Yi for that travel mode. In such implementations, differences in the frequency of use among the travel modes may lead to differences in the progress of learning of electrical efficiency among the different travel modes. The differences in the progress of learning could destroy the correlation between assist level and the calculated electrical efficiency or remaining available distance with assistance, for example. In contrast, in the implementation of FIG. 7, the electrical efficiency yi(k) for each travel mode is calculated by correcting a common interval electrical efficiency x(k) and long distance electrical efficiency Yi shared by all travel modes, i.e., the plurality of travel modes. Calculating a single learned electrical efficiency for travel in a plurality of travel modes and correcting this to calculate the electrical efficiency for each travel mode will avoid inconsistencies in calculation results due to differences in the progress of learning that depend on the travel mode.

The process of correcting y(k) to calculate the electrical efficiency yi(k) for travel mode i is not limited to the exemplary implementation in FIG. 7. For example, other than motor output, the correction value used may be the electric power consumed by the motor, the discharge power of the battery, or any other value relating to electric power used. Further, although the implementation of FIG. 7 calculates the correction value using an average value for the plurality of travel modes and values for the various travel modes, the correction value used may be a fixed value predetermined for each travel mode.

The calculation of an interval electrical efficiency for each interval acquired by the interval electrical efficiency acquisition unit 51 is not limited to the above exemplary method. For example, an interval electrical efficiency for each interval may be calculated using a moving average of electric power consumed in, or electrical efficiency for, individual sub-intervals of that interval. For example, an average electric power consumed in sub-intervals of a latest interval may be successively calculated each time the vehicle travels one sub-interval to provide a moving average, which may be used as the electric power consumed in each interval to calculate interval electrical efficiency. In such implementations, each interval overlaps another interval. Further, interval electrical efficiency is calculated for each sub-interval. Alternatively, a representative value of the moving average of electric power consumed in a plurality of sub-intervals included in one interval (e.g., average value) may be used as the electric power consumed in one interval to calculate interval electrical efficiency. In such implementations, each interval does not overlap another interval, and interval electrical efficiency may be calculated for each interval.

A predetermined travel distance d may be set based on characteristics of the electric vehicle 10. In implementations where the electric vehicle 10 is an electric motor-assisted bicycle, the predetermined travel distance d may be set to a value in the range of 1 m to 20 km, for example. For example, if the predetermined travel distance d is set to a value in the range of 1 m to 5 km, an electrical efficiency and an available travel distance may be calculated that finely follow changes in use conditions of the electric motor-assisted bicycle. To achieve fine follow-up performance, for example, preferably 1 m≤d≤1 km, more preferably 1 m≤d≤500 m, and yet more preferably 1 m≤d≤250 m. To provide follow-up performance relating to average common changes in use conditions, for example, preferably 100 m≤d≤15 km, more preferably 100 m≤d≤10 km, and yet more preferably 100 m <d<5 km.

Although not limiting, the weighting factor α may be P/2>α, for example. Thus, the degree of contribution of the newest interval electrical efficiency will be higher than the degree of contribution of the long distance electrical efficiency. This will facilitate calculation of an electrical efficiency that strikes a balance between follow-up performance and stability relative to use conditions. If importance is placed on follow-up performance, then, preferably P/5>α, and more preferably P/10>α. If importance is placed on stability, then, preferably P/2<α, and more preferably P/5<α. Here, 0<α<p. The constant P is not limited to any particular value, and may be P=1×10\hat{ }n (n is an integral), for example.

Further, a weighting factor α may be set taking into account its relationship with the predetermined travel distance d. For example, increasing the predetermined travel distance d levels off the travel environment and thus increases stability. Thus, α may be reduced to increase follow-up performance to strike a balance. Reducing the predetermined travel distance d leaves the travel environment less leveled off and thus reduces stability. Thus, α may be increased to reduce follow-up performance to strike a balance. Although not limiting, to specify exemplary ranges of α and d, when 100 m≤d≤10 km, then P/2>α>P/100, which will further improve the balance between follow-up performance and stability.

At least one of the weighting factor α and predetermined travel distance d may be updatable in response to a user input. The electrical efficiency calculation system 50 may receive input of an instruction to update at least one of the weighting factor α and predetermined travel distance d. For example, an update instruction by the user is input through the input device 72 of the UI unit 70 included in the electric vehicle 10. When receiving input of an update instruction, the electrical efficiency calculation system 50 may receive input regarding both the level of follow-up performance and the level of stability from the user. In such implementations, updated values of a and d may be decided upon depending on the level of follow-up performance and the level of stability input by the user. The weighting factor α and predetermined travel distance d are stored on a storage device accessible to the electrical efficiency calculation system 50.

The electric vehicle according to example embodiments of the present invention may be an electric motor-assisted bicycle or, for example, an electric bicycle or electrically driven motorcycle with pedals (i.e., electric moped). Further, the electric vehicle is not limited to two-wheeled vehicles, and may be a vehicle with three or more wheels.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A system for calculating an electrical efficiency of an electric vehicle, the system comprising:
one or more controllers configured or programmed to define and function as:
an interval electrical efficiency acquisition unit configured or programmed to acquire an interval electrical efficiency of the electric vehicle for each interval of a predetermined travel distance based on electric power consumed by the electric vehicle in the respective interval;
a long distance electrical efficiency acquisition unit configured or programmed to acquire a long distance electrical efficiency based on electric power consumed by the electric vehicle in a travel distance longer than the predetermined travel distance; and
an electrical efficiency calculation unit configured or programmed to calculate the electrical efficiency of the electric vehicle using a value obtained by multiplying a newest interval electrical efficiency and the long distance electrical efficiency by respective weighting factors, the newest interval electrical efficiency being an interval electrical efficiency for a newest interval acquired by the interval electrical efficiency acquisition unit.

2. The system according to claim 1, wherein the electrical efficiency calculation unit is configured or programmed to calculate the electrical efficiency using a sum of a value obtained by multiplying the newest interval electrical efficiency by P-a as the respective weighting factor and a value obtained by multiplying the long distance electrical efficiency by a as the respective weighting factor, where P is a constant, and 0<α<P.

3. The system according to claim 1, wherein, the long distance electrical efficiency is a multiple-interval electrical efficiency calculated based on electric power consumed in a plurality of intervals, or a total travel distance electrical efficiency calculated based on electric power consumed in the total travel distance of the electric vehicle.

4. The system according to claim 1, wherein
the long distance electrical efficiency acquisition unit is configured or programmed to acquire, as the long distance electrical efficiency, a previous electrical efficiency calculated by the electrical efficiency calculation unit with respect to a last interval before the newest interval; and
the electrical efficiency calculation unit is configured or programmed to calculate the electrical efficiency using a value obtained by multiplying the newest interval electrical efficiency and the previous electrical efficiency by respective weighting factors.

5. The system according to claim 1, wherein
the long distance electrical efficiency acquisition unit is configured or programmed to acquire, as the long distance electrical efficiency, a total travel distance electrical efficiency calculated based on electric power consumed in a total travel distance of the electric vehicle; and
the electrical efficiency calculation unit is configured or programmed to calculate the electrical efficiency using a value obtained by multiplying the newest interval electrical efficiency and the total travel distance electrical efficiency by respective weighting factors.

6. A system for calculating an available travel distance of an electric vehicle, the system comprising:
the electrical efficiency calculation system according to claim 1; and
one or more controllers configured or programmed to define and function as:
a residual battery capacity acquisition unit configured or programmed to acquire a residual battery capacity of a battery included in the electric vehicle; and
an available travel distance calculation unit configured or programmed to calculate the available travel distance using the electrical efficiency calculated by the electrical efficiency calculation unit and the residual battery capacity, the available travel distance being a distance that the vehicle is able to travel using electric power from the battery of the electric vehicle.

7. The system according to claim 1, wherein the weighting factor for the newest interval electrical efficiency is larger than the weighting factor for the long distance electrical efficiency.

8. The system according to claim 1, wherein the weighting factor for the newest interval electrical efficiency and the weighting factor for the long distance electrical efficiency are updatable in response to an input by a user.

9. The system according to claim 1, wherein
the electric vehicle is able to switch among a plurality of travel modes that use electric power in response to a selection operation by a user; and
the electrical efficiency calculation unit is configured or programmed to calculate an electrical efficiency for the travel mode selected by the user.

10. The system according to claim 1, wherein the electric vehicle is an electric motor-assisted bicycle including a motor to output an assist force depending on a pedaling force input to a pedal.

11. The system according to claim 6, wherein
the electric vehicle is an electric motor-assisted bicycle; and
the available travel distance is an available assisted travel distance that the vehicle is able to travel with assistance that uses electric power from the battery.

12. A non-transitory storage medium storing a program for calculating an electrical efficiency of an electric vehicle, the program causing a computer to perform:
an interval electrical efficiency acquisition process in which an interval electrical efficiency of the electric vehicle for each interval of a predetermined travel distance based on electric power consumed by the electric vehicle in the respective interval is acquired;
a long distance electrical efficiency acquisition process in which a long distance electrical efficiency based on electric power consumed by the electric vehicle in a travel distance longer than the predetermined travel distance is acquired; and
an electrical efficiency calculation process in which the electrical efficiency of the electric vehicle is calculated using a value obtained by multiplying a newest interval electrical efficiency and the long distance electrical efficiency by respective weighting factors, the newest interval electrical efficiency being an interval electrical efficiency for a newest interval acquired in the interval electrical efficiency acquisition process.

13. A method of calculating an electrical efficiency of an electric vehicle performed by a computer, the method comprising:
an interval electrical efficiency acquisition step in which an interval electrical efficiency of the electric vehicle for each interval of a predetermined travel distance based on electric power consumed by the electric vehicle in the respective interval is acquired;
a long distance electrical efficiency acquisition step in which a long distance electrical efficiency based on electric power consumed by the electric vehicle in a travel distance longer than the predetermined travel distance is acquired; and
an electrical efficiency calculation step in which the electrical efficiency of the electric vehicle is calculated using a value obtained by multiplying a newest interval electrical efficiency and the long distance electrical efficiency by respective weighting factors, the newest interval electrical efficiency being an interval electrical efficiency for a newest interval acquired at the interval electrical efficiency acquisition step.
